(19) United States
(12) Patent Application Publication
(10) Pub. No.: US 2005/0251464 A1
(43) Pub. Date: Nov. 10, 2005

(54) Method and system for automating an audit process

(76) Inventors: Bradley Christopher Ames, San Jose, CA (US); Carrie Jean Marquardson, Palo Alto, CA (US); Steven Bradford Stein, Laguna Niguel, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/842,758

(22) Filed: May 10, 2004

(51) Int. Cl. G06F 17/60

(52) U.S. Cl. 705/35; 705/36

(57) ABSTRACT

A method for automating an audit process is disclosed. The method includes automatically accessing data pertinent to process-based leading indicators and symptomatic lagging indicators, wherein the plurality of process-based leading indicators is correlated with the plurality of symptomatic lagging indicators. The data is then stored and, when appropriate, results are generated.

### FIELD OF INVENTION

The present invention relates to the field of risk assessment methodology. In particular, the present invention relates to a method for automating an audit process and reporting risk for adaptive environments.

### BACKGROUND

The outsourcing of Information Technology (IT) services is a common practice in today's business environment. As such, a company that is managing its customer's outsourced IT functions is managing risk on behalf of its customer. Customers expect visibility as to how the managing company is managing the processes that they, the customer, have chosen to outsource. Currently, the most common and widely accepted form of seeing how processes are managed is that of performing an on-site audit examination. However, audit examinations are static, time consuming and expensive.

In addition, the passing into law of the Sarbanes-Oxley Act of 2002 requires annual attestation of control activities by an external auditor. Sarbanes-Oxley will require all U.S. publicly traded companies to attest to their internal control environment. A company managing a portion of its customers control environment will, therefore, need to provide assurance to its customers.

External auditors drive a majority of audit requests, as they are required to assess risks for their clients. Currently, external auditors request a Statement on Auditing Standard No. 70 (SAS 70) service auditor's report from the outsourced management companies. SAS 70 reports are auditor-to-auditor communications and are expensive, intrusive, and historical in nature.

Previously, corporate governance leaders and decision makers gained assurance through cyclical audit examinations recurring annually. However, subsequent changes in the control environment tend to expand risk, increase uncertainty and diminish the relevance of a retrospective audit report. Cyclical audits are typically localized, static, time-consuming events that provide limited visibility to emerging risk. In other words, cyclical audits provide a snapshot of the condition of internal controls, taken at the time of the audit. From audit to audit the condition of internal controls is virtually unknown. There is little, if any, forecasting that occurs at an on-site cyclical audit.

Furthermore, since most fieldwork requires an auditor to be on-site in order to conduct examination testing, the requirement for auditor manpower can be very high. The advance of the global, adaptive enterprise has created a demand for more timely assurance throughout the year on a broader range of risk factors than that traditionally provided by cyclical audits. The Sarbanes-Oxley Act of 2002 requires more frequent reviews of the adequacy of controls and risk, which will further stretch audit resources.

### SUMMARY

A method for automating an audit process is disclosed. The method includes automatically accessing data pertinent to process-based leading indicators and symptomatic lagging indicators, wherein the plurality of process-based leading indicators is correlated with the plurality of symptomatic lagging indicators. The data is then stored and, when appropriate, results are generated.

### BRIEF DESCRIPTION OF THE DRAWINGS

FIG. 1 is a flow diagram for a method of automating an audit process, according to one embodiment of the present invention.

FIGS. 2A, 2B and 2C are lists illustrating exemplary samples of process-based leading indicators and symptomatic lagging indicators for security, maintenance and availability categories, respectively, related to an Informational Technology application, in accordance with one embodiment of the present invention.

FIG. 3 is a flow diagram for a method of forecasting the effectiveness and efficiency of controls using process-based indicators, in accordance with one embodiment of the present invention.

FIG. 4 is a graph illustrating an exemplary report showing the trending and forecasting of a symptomatic lagging indicator, in accordance with one embodiment of the present invention.

FIG. 5 is a block diagram of a forecasting system for predicting the effectiveness and efficiency of controls using process-based indicators, in accordance with one embodiment of the present invention.

FIG. 6 is a block diagram of a generic computer system on which embodiments of the present invention may be performed.

### DETAILED DESCRIPTION

Reference will now be made in detail to embodiments of the invention, examples of which are illustrated in the accompanying drawings. While the invention will be described in conjunction with the embodiments, it will be understood that they are not intended to limit the invention to these embodiments. Furthermore, in the following detailed description, numerous specific details are set forth in order to provide a thorough understanding of the present invention. In other instances, well known methods, procedures, and components have not been described in detail so as not to unnecessarily obscure aspects of the present invention.

The following detailed description pertains to automating an audit process. For purposes of clarity and brevity, the following discussion will explain the present method and system with respect to an Informational Technology (IT) environment. It should be noted, however, that although such an example is explicitly provided below, the method and system of the present invention is well suited to use with various other types of auditable environments including, but not limited to, IT environments (e.g., financial audits, operational audits, etc.).

Embodiments of the present invention include a method and a system for automating an audit process and forecasting risk for adaptive environments. The automated audit process is a tool set for continuously monitoring emerging risk in an adaptive control environment. The monitoring model measures leading and lagging indicators of IT risk related to critical business processes. The indicators are gathered periodically, systematically and remotely from application systems and host platforms. Results of monitoring are organized in categories that are meaningful to controllership, corporate governance, internal auditors and external auditors. Indicators of risk and management's response to risk are compared and trended over time by aligning the monitoring results of key financial processes (e.g., account reconciliation), business applications (e.g., SAP application) and related technologies (e.g., UNIX). Through ongoing measurement of dispersed, key processes and data, management and auditors are given clear visibility to the control environment, how it is adapting to change and where it is headed. One goal is that corrections may be implemented before problems occur. This visibility generates comfort without performing an audit examination or even being in close proximity to the process.

Embodiments of the present invention give an overall enterprise view of instances of applications. The main purpose of the present invention is to indicate major changes in sensitive areas. This is achieved by taking a periodic or continuous snapshot of all systems and storing the information for history and comparison reports. This allows an audit team to have a constant overview at the whole application landscape and to identify critical changes on systems.

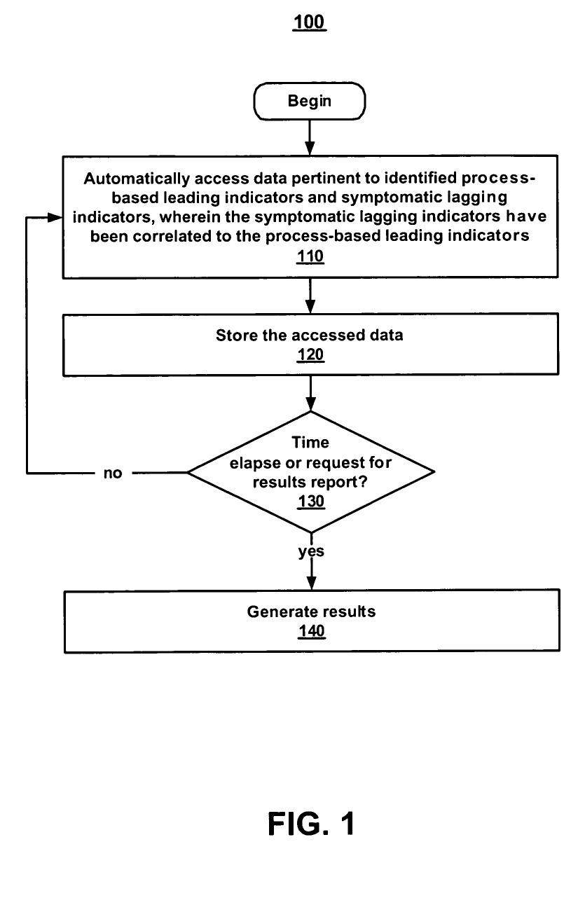

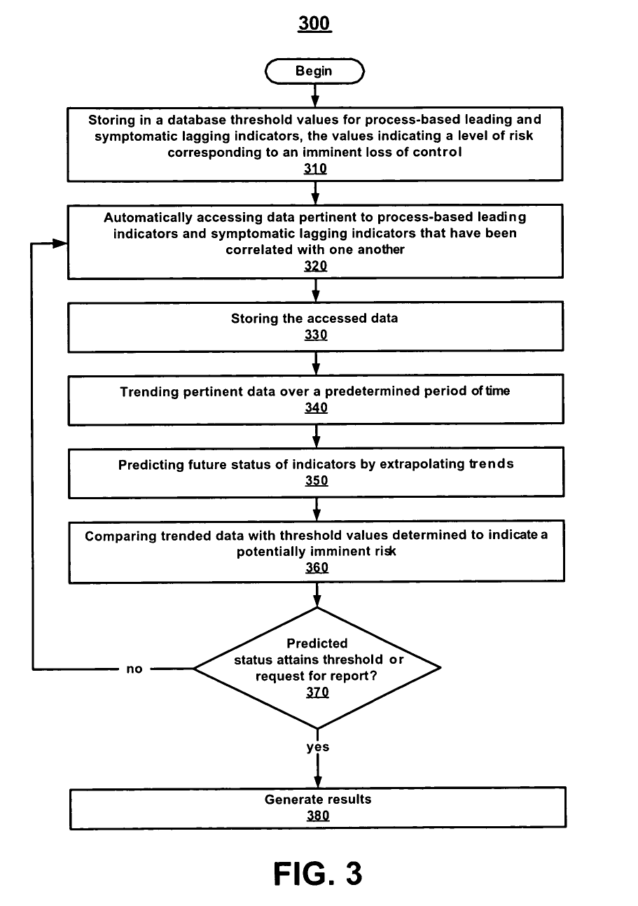

Certain portions of the detailed descriptions of embodiments of the invention, which follow, are presented in terms of processes and methods (e.g., Method 100 of FIG. 1 and method 300 of FIG. 3). Although specific steps are disclosed herein describing the operations of these processes and methods, such steps are exemplary. That is, embodiments of the present invention are well suited to performing various other steps or variations of the steps recited in the flowcharts of the figures herein.

### AUTOMATING AN AUDIT

FIG. 1 is a flow diagram of a method 100 for automating an audit process, according to one embodiment of the present invention. At step 110 of method 100, data pertinent to identified process-based leading indicators and symptomatic lagging indicators is automatically accessed, wherein the process-based leading indicators are correlated with one or more related symptomatic lagging indicators. For purposes of the present application, the term “process-based leading indicator is intended to mean an indicator which measures an activity or procedure that is part of internal control. Such control activities are typically designed by management to prevent errors from being introduced into the system. (e.g., granting access restrictions to certain capabilities). Additionally, the term “symptomatic lagging indicator” is intended to mean an indicator which measures the affect of the control activity in the data. This indicator would typically detect occurrences of error that may have been introduced in the system (e.g., a transaction that was improperly authorized).

These process-based leading indicators for risk assessment that are identified for monitoring have been determined empirically from a database of information accumulated over many on-site audits. These process-based indicators may also be derived from widely accepted best practices and known risk areas across the audit profession. As an example, if a process entails the granting, modifying and removing of access or user privileges on a system application, some process-based leading indicators of risk may be the determining if the process is repeatable, if privilege system accounts are restricted to IT users, or if privileges are commensurate with job function.

According to one embodiment of the present invention, each of the process-based leading indicators is aligned with a relevant category. For example, the process-based leading indicators mentioned above as associated with the IT processes of granting, modifying and removing privileges may be associated with the category of system security. Other IT risk categories may be those of maintenance of a system and availability of a system. The categories may be any categories for which processes afford potential risk and for any discipline in which an audit process is appropriate. The risk categories for any particular discipline are typically identified to be those in which a human being may introduce an error into a system or process.

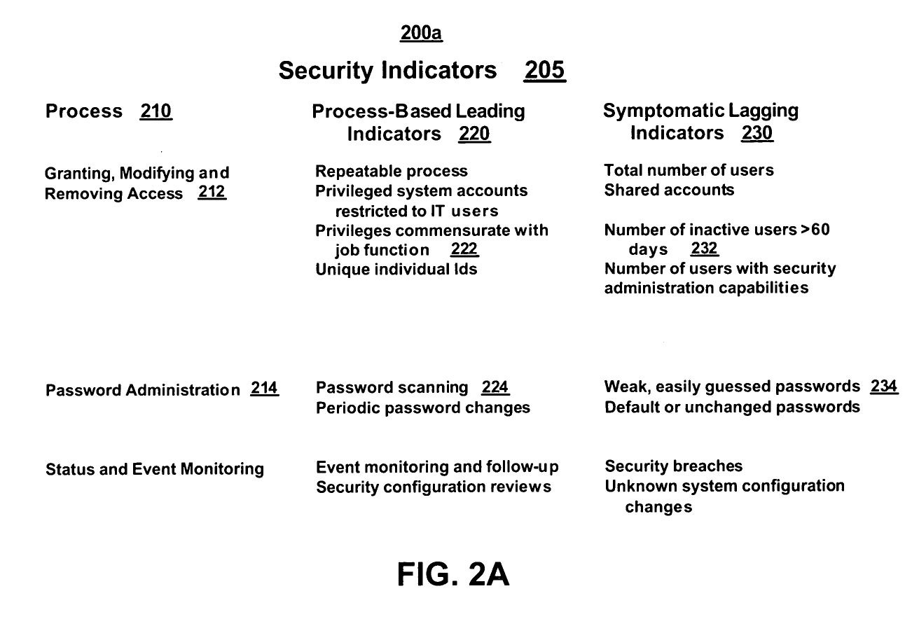

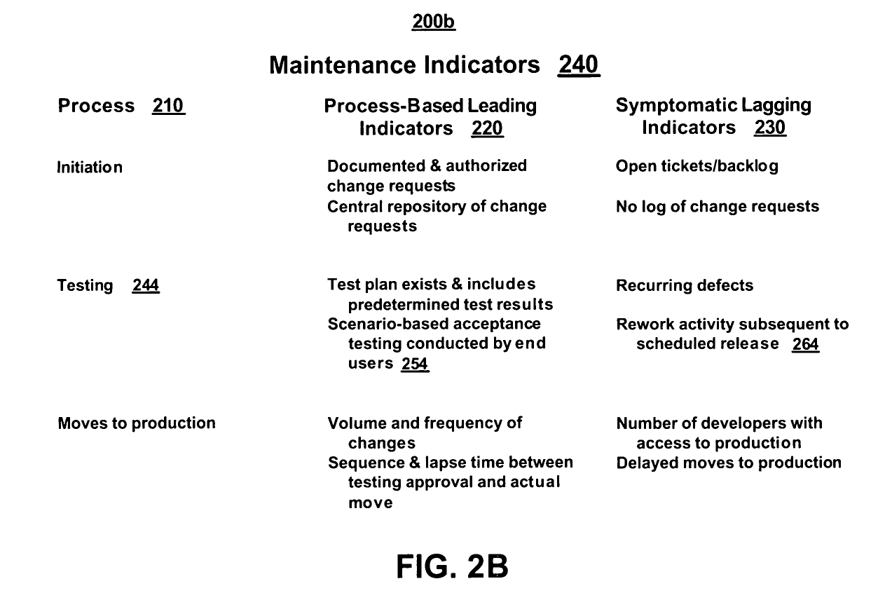

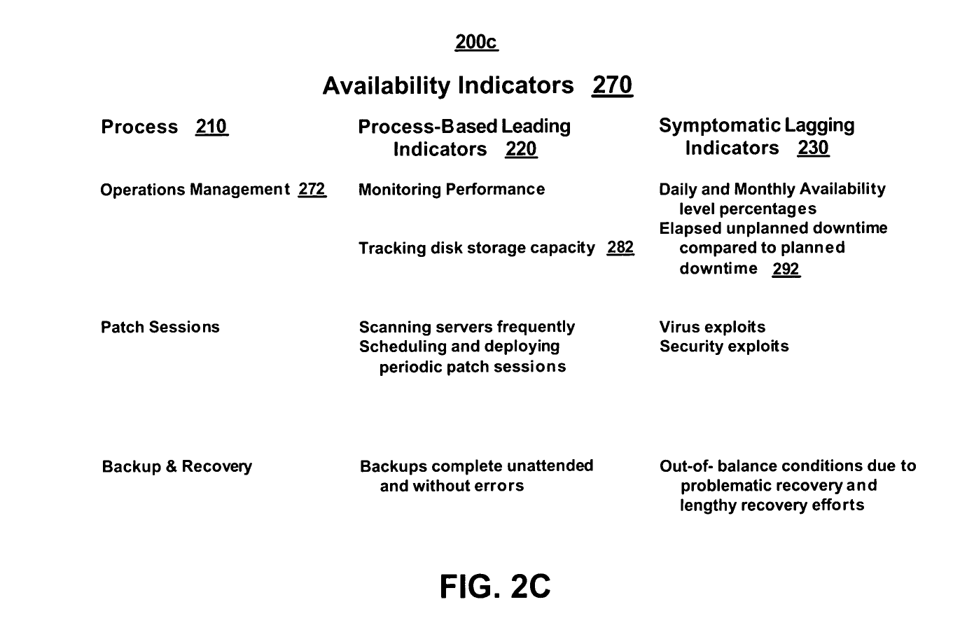

Referring still to step 110 of method 100, once the process-based leading indicators have been identified for the respective relevant categories, in accordance with one embodiment of the present invention, symptomatic lagging indicators are determined. Often the symptomatic lagging indicators are non-obvious. For example, it has been determined that a lagging indicator for a breach in the security of a system is that of a large number of inactive accounts, a non-obvious relationship. It has been determined that if too much access is granted to holders of accounts, they can perform tasks that are beyond the scope of their job function, and a breach of security can occur. If there is a large number of inactive accounts, it indicates that the accounts are not being monitored and cleared out in a timely manner, which is further indicative of there being insufficient controls in the security process of granting, modifying and removing access. FIGS. 2A, 2B and 2C below show a few exemplary process-based indicators for categories of security, maintenance and availability, respectively.

In one embodiment, after the process-based leading indicators are aligned with a relevant category and correlated with symptomatic lagging indicators, access to data pertinent to the indicators is automated. The pertinent data may be collected from any number of applications or systems (e.g., SAP systems) by a monitoring system.

Still referring to step 110 of FIG. 1, one part of the data (PULL-data) can be delivered by a client module that is installed on every application instance. The areas covered by the data pull may be data such as User data, Role/Profile data and critical transaction data. Another part of the data (PUSH-data) may need to be entered by system-responsible persons and cover Availability and Maintenance information. One purpose of the automated process is to show trends in the single key risk indicators of an application/system as there is a data history available for every application/system. However, reporting tools also allow a comparison of data between different systems.

At step 120 of method 100, the data that has been accessed is stored within the system for retrieval at an appropriate time, according to an embodiment of the present invention. An appropriate time may be when a predetermined time period has elapsed, when data reaches a predetermined value or when a user-demand is executed.

At step 130 of method 100, a check is performed to determine if it is appropriate to generate results, according to one embodiment of the present invention. A regular periodic reporting period, (e.g., once per month, once per week or once per quarter) may be predetermined and configured into the application/system. The attaining of one of these preconfigured time periods may trigger the generation of results. According to one embodiment, there may be a comparison of pertinent data with predetermined threshold values and, if the data attains the threshold value or a pre-specified fraction of such a threshold value, there may be an alert message generated. If it is not an appropriate time to generate results, the method continues to access and store the pertinent data until such time as generated results are appropriate.

At step 140 of method 100 of FIG. 1, results are generated. The results may be in the form of a listing of pertinent data, a bar chart, a graph or an alert message, or any appropriate output for reporting the data. The results may be for one or any number of applications and may be cumulative or comparative. That is, the results may include data pertinent to a process-based indicator for a single application instance or the accumulated values for all instances. Also, the data may be compared from instance to instance or between sets of instances. Instances are representative of business processes in world-wide business operational units and geographies.

FIGS. 2A, 2B and 2C illustrate exemplary sets of process-based leading indicators and symptomatic lagging indicators for security, maintenance and availability processes, respectively, related to an Informational Technology (IT) application, in accordance with one embodiment of the present invention. It should be understood that embodiments of the present invention are well suited for disciplines other than IT and that appropriate process-based indicators may be generated for processes related to other disciplines (e.g., finance, operations, etc.).

FIG. 2A shows, according to one embodiment, an example of a small sample listing 200a of security indicators 205 with their associated processes 210, process-based leading indicators 220 and symptomatic lagging indicators 230. For the process of granting, modifying and removing access 212, a typical example of a leading indicator may be that of privileges being commensurate with job function 222. As discussed earlier, when too much access is granted, it is easy for a security breach to occur, often inadvertently. If the people setting up security are not sufficiently diligent in establishing and enforcing controls, users can misbehave on a system. Thus, a symptomatic lagging indicator for privileges being commensurate with job function may be the number of inactive users >60 days 232. Although the significance of this lagging indicator may not be immediately obvious, it could be indicative of lack of diligence in security control.

Still referring to FIG. 2A, another example of a security process 210 with associated process-based leading indicators 220 and symptomatic lagging indicators 230 is that of process password administration 214. An example of a leading indicator might be that of scanning the quality of passwords 224, a control process that might prevent the symptomatic lagging indicator of weak, easily guessed passwords 234, which, in turn, may cause a breach of security.

Referring now to FIG. 2B, according to an embodiment of the present invention, an example of a small sample listing 200b of maintenance indicators 240 with their associated processes 210, process-based leading indicators 220 and symptomatic lagging indicators 230 is illustrated. For the process of testing 244, a typical example of a leading indicator may be that of having scenario-based acceptance testing conducted by end users 245. Without this control in place, a symptomatic lagging indicator may be, for example, having to schedule and perform rework activities subsequent to scheduled release 264.

FIG. 2C shows an example of a small sample listing 200c of availability indicators 270 with their associated processes 210, process-based leading indicators 220 and symptomatic lagging indicators 230. For the process of operations management 272, a typical example of a leading indicator may be that of tracking disk storage capacity 282. A symptomatic lagging indicator may be that of having a large percentage of unplanned downtime compared to planned downtime 292. In this case, the relationship stems from the fact that unplanned downtime may well be the result insufficient disk storage space, although this may not be immediately obvious. If the administrators who on track disk storage capacity were sufficiently diligent, it may be expected that the number of unplanned outages may be reduced.

A large volume of leading and lagging indicators may be correlated following accumulation of data over multiple audit cycles. This correlation of frequently non-obvious indicators is crucial to the automation of an audit process, in accordance with embodiments of the present invention.

### FORECASTING RISK USING AN AUTOMATED AUDIT

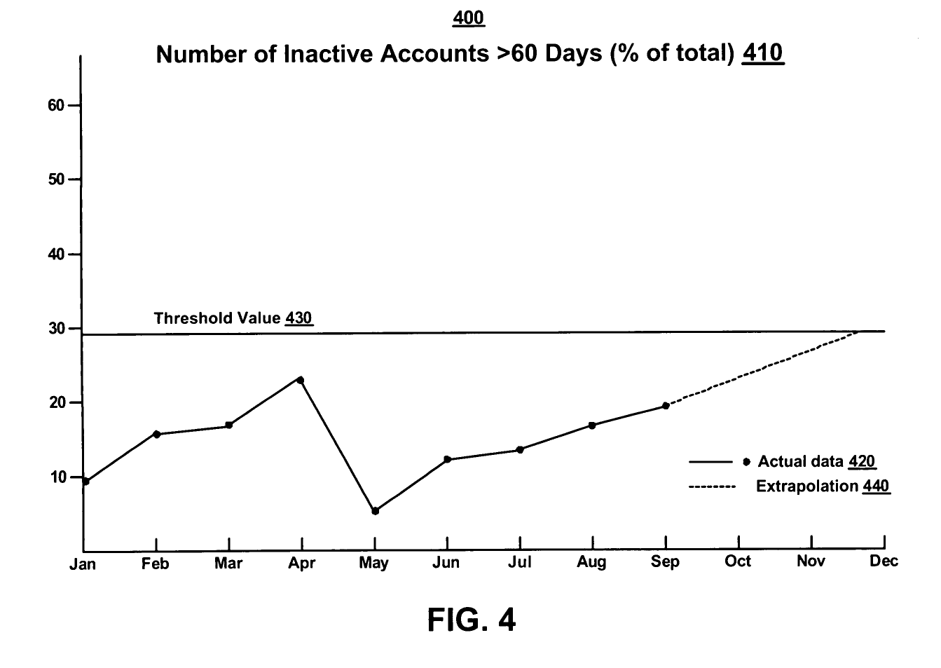

FIG. 3 is a flow diagram for a method 300 of forecasting the effectiveness and efficiency of controls using process-based indicators, in accordance with one embodiment of the present invention. Portions of method 300 will be discussed in concert with FIG. 4, wherein FIG. 4 is a graph illustrating an exemplary report showing the trending and forecasting of a symptomatic lagging indicator, in accordance with one embodiment of the present invention.

At step 310 of method 300, according to one embodiment of the present invention, a threshold value is stored in a database, when pertinent, for each of a set of process-based leading indicators and symptomatic lagging indicators, wherein the threshold value indicates a level of risk corresponding to an imminent loss of control. These threshold values are derived empirically from data collected over numerous instances of on-site audits and analyzed to determine at what level of risk the controls of a particular process become ineffective. These process-based indicators may also be derived from widely accepted best practices and known risk areas across the audit profession. The threshold values may be percentages, fractions or absolute values, depending on the type of data for which they apply. Further, in one embodiment, the threshold value pertains to a process-based leading indicator. In another embodiment, the threshold value pertains to a symptomatic lagging indicator. Also, in yet another embodiment, the threshold value pertains to a combination of the process-based leading indicator and one or more corresponding symptomatic lagging indicators.

At step 320 of method 300, data pertinent to a plurality of process-based leading indicators and a plurality of symptomatic lagging indicators is accessed. The process-based leading indicators have been previously correlated with the plurality of symptomatic lagging indicators. These process-based leading indicators for risk assessment that are identified for monitoring have been determined empirically from a database of information accumulated over many on-site audits. These process-based indicators may also be derived from widely accepted best practices and known risk areas across the audit profession. As an example, if a process entails the granting, modifying and removing of access or user privileges on a system application, some process-based leading indicators of risk may be the determining if the process is repeatable, if privilege system accounts are restricted to IT users, or if privileges are commensurate with job function.

According to one embodiment of the present invention, each of the process-based leading indicators is aligned with a relevant category. For example, the process-based leading indicators mentioned above as associated with the IT processes of granting, modifying and removing privileges may be associated with the category of system security. Other IT risk categories may be those of maintenance of a system and availability of a system. The categories may be any categories for which processes afford potential risk and for any discipline in which an audit is appropriate. The risk categories for any particular discipline are typically identified to be those in which a human being may introduce an error into a system or process.

Referring still to step 320 of method 300, once the process-based leading indicators have been identified for the respective relevant categories, in accordance with one embodiment of the present invention, symptomatic lagging indicators are determined. Often the symptomatic lagging indicators are non-obvious. For example, it has been determined that a lagging indicator for a breach in the security of a system is that of a large number of inactive accounts, a non-obvious relationship. It should be noted that there may be several symptomatic lagging indicators corresponding to a single process-based leading indicator.

It has been determined that if too much access is granted to holders of accounts, they can perform tasks that are beyond the scope of their job function, and a breach of security can occur. If there is a large number of inactive accounts, it indicates that the accounts are not being monitored and removed from the application in a timely manner, which is further indicative of there being insufficient controls in the security process of granting, modifying and removing access. FIGS. 2A, 2B and 2C above show a few exemplary process-based indicators for categories of security, maintenance and availability, respectively.

In one embodiment, after the process-based leading indicators are aligned with a relevant category and correlated with symptomatic lagging indicators, access to data pertinent to the indicators is automated. The pertinent data may be collected from any number of applications or systems (e.g., SAP systems) by a monitoring system.

At step 330 of method 300, according to one embodiment, the accessed data is stored by the monitoring system until an appropriate time elapses, a user demand is received or an event occurs to trigger the generation of results.

At step 340 of FIG. 3, according to one embodiment of the present invention, the data may be trended. For an example, if the data were accumulated on a monthly basis, it could be trended for a quarter, a number of quarters, or for one or more years. The data may be trended for a single instance of an application, or for an accumulation of many applications.

Referring to FIG. 4, a graph illustrating an example of trending and forecasting of a symptomatic lagging indicator is presented, in accordance with one embodiment of the present invention. In the present example, the percent of the actual data 420 showing a total number of accounts that have been inactive in excess of 60 days 410 is shown to be trended on a monthly basis over a period of two quarters plus two months into a third quarter.

In this example, according to one embodiment of the present invention, a threshold value 430 is shown to exist when 30 percent of all accounts have been inactive for at least 30 days. This indicates that, should the actual percentage of inactive accounts reach the threshold value 430 of 30 percent, the security controls (e.g., for granting, modifying and removing access as shown in FIG. 2A) would be considered to have broken down, showing that the system administrators may not be diligent in monitoring accounts. When the data are accessed, the values may be compared to the stored threshold values to determine if an alert message may be appropriate.

In the present example of FIG. 4, it can be seen that the trend of actual data 420 that started at approximately 12% inactive accounts in January, rose through February and March to reach a high of approximately 25% inactive accounts in April. In May, it appears that the trend had been noticed and that a correction had been made (e.g., inactive accounts removed from the application) so that the percentage of inactive accounts was back down to around 5%. This would indicate that the controls were in place and that the administrators were being diligent. Then, the trend can be seen to increase again over the next 4 months with no corrections being made.

Referring back to FIG. 3, at step 350, a future status of the data, based on an extrapolation of the trending, is predicted, according to an embodiment of the present invention. In the example shown in FIG. 4, the extrapolation 440 can be seen as a simple linear extrapolation the would predict that the threshold value 430 of 30 percent inactive accounts could be reached in mid-November. Depending on the type of data being monitored and the periodicity of the monitoring, any mathematical extrapolation that would characterize the trend of the data may be used.

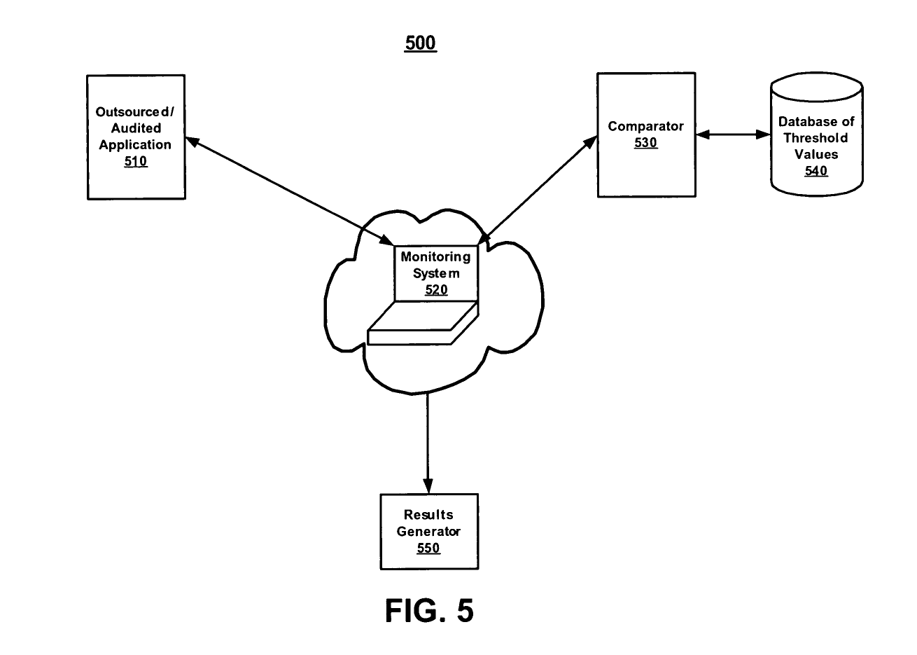

At step 370 of method 300, according to one embodiment, a check is made to see if the predicted future status will reach its threshold value, or if there is a request for a report. According to an embodiment of the present invention, when the future status of the data indicates the attaining of a threshold value, the monitoring system may request that the results generator issue an alert message to indicate the potential loss of control at the future date. Also, should the data reach its threshold value, as determined by a comparison of the accessed data with its threshold value (e.g., by comparator 530 of FIG. 5), an alert message may be issued. The alert messages may be sent to the appropriate system administrator, as well as to corporate governance and auditors, alerting them of a potential breakdown of controls.

There may also be a request for a report to be generated, either by user demand or be a period of time having elapsed that triggers a report. If there is no request for an alert message to be generated or for results to be reported, method 380 returns to step 320 and continues. If there is a request for an alert message or a report, method 300 proceeds to step 380.

At step 380 of FIG. 3, results are generated. The results may be in the form of a listing of pertinent data, a bar chart, a graph or an alert message, or any appropriate output for reporting the data. The results may be for one or any number of applications and may be cumulative or comparative. That is, the results may include data pertinent to a process-based indicator for a single application instance or the accumulated values for all instances. Also, the data may be compared from instance to instance or between sets of instances.

### SYSTEM FOR GENERATING AN AUTOMATED AUDIT

FIG. 5 is a block diagram of a forecasting system 500 for predicting the effectiveness and efficiency of controls using process-based risk indicators, in accordance with one embodiment of the present invention. Outsourced/Audited Application 510 of FIG. 5 is an application (e.g., an SAP application) for which controls are being monitored in order to determine their effectiveness and efficiency. These controls are characterized in terms of process-based risk indicators, both leading and (symptomatic) lagging. Examples of such indicators are discussed in detail in conjunction with FIGS. 2A, 2B and 2C above.

A monitoring system 520 of FIG. 5 receives and stores pertinent data from Outsourced/Audited Application 510 that relates to the process-based indicators, according to one embodiment. This data is received from Outsourced/Audited Application 510 on a predetermined periodic basis. The periodicity for receiving the data may be hourly, daily, weekly or monthly, or for any interval that would be determined as effective for a particular set of data being monitored. The data is then stored by monitoring system 520. In one embodiment the monitoring system 520 trends the data over predetermined time intervals. In another embodiment, monitoring system 520 extrapolates the data in order to forecast a future level of risk.

Database 540 of FIG. 5 contains threshold values for the data related to process-based indicators, according to an embodiment of the present invention. These threshold values are systematically determined empirically from sets of data. The threshold values, when attained, indicate a level of risk indicative of an imminent loss of control for which an alert message may be generated. The alert message can be made available to a spectrum of interested parties such as, for example, corporate management, internal auditors, external auditors, etc.

According to one embodiment of the present invention, Comparator 530 compares the data received by Monitoring System 520 to the relevant threshold values from database 540 and forwards the comparison data to monitoring system 520 for deciding if an alert message is appropriate.

Still referring to FIG. 5, Results Generator 550 generates results in the form of reports and alert messages, in accordance with one embodiment of the present invention. The reports may be lists of values of data relating to the process-based indicators, graphs (e.g., the graph shown in FIG. 4), bar charts, or any format appropriate for reporting a particular set of data. The results may be for one or any number of applications and may be cumulative or comparative. That is, the results may include data pertinent to a process-based indicator for a single application instance or the accumulated values for all instances. Also, the data may be compared from instance to instance or between sets of instances. Alert messages may also be generated by Report Generator 550 when the Monitoring System 520 determines from Comparator 530 data that a threshold value has been, or is about to be, attained.

### COMPUTER SYSTEM FOR PERFORMING AUTOMATED AUDIT

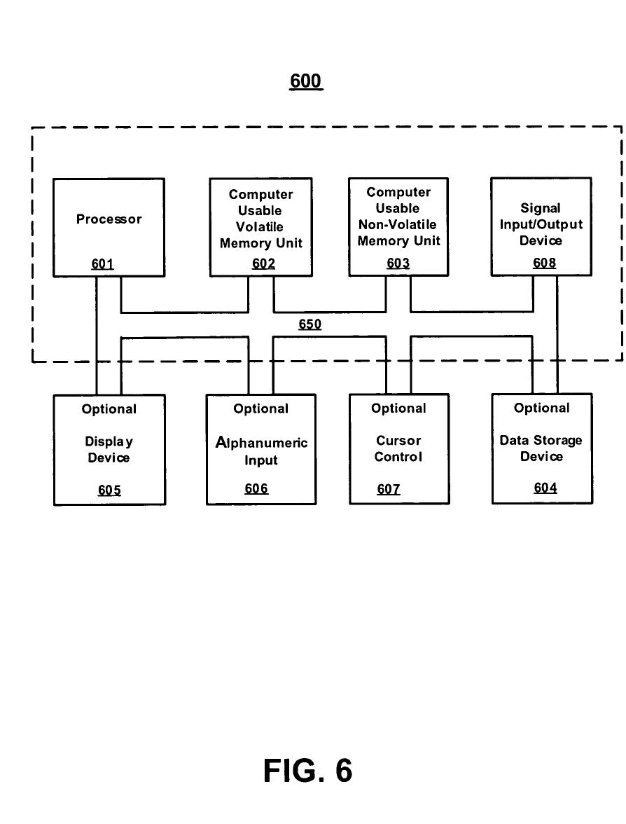

Refer now to FIG. 6. The software components of embodiments of the present invention run on computers. A configuration typical to a generic computer system is illustrated, in block diagram form, in accordance with one embodiment of the present invention, in FIG. 6. Generic computer 600 is characterized by a processor 601, connected electronically by a bus 650 to a volatile memory 602, a non-volatile memory 603, possibly some form of data storage device 604 and a display device 605. It is noted that display device 605 can be implemented in different forms. While a video cathode ray tube (CRT) or liquid crystal diode (LCD) screen is common, this embodiment can be implemented with other devices or possibly none. System management is able, with this embodiment of the present invention, to determine the actual location of the means of output of alert flags and the location is not limited to the physical device in which this embodiment of the present invention is resident.

Similarly connected via bus 650 are a possible alphanumeric input device 606, cursor control 607, and signal I/O device 608. Alphanumeric input device 606 may be implemented as any number of possible devices, including video CRT and LCD devices. However, embodiments of the present invention can operate in systems wherein intrusion detection is located remotely from a system management device, obviating the need for a directly connected display device and for an alphanumeric input device. Similarly, the employment of cursor control 607 is predicated on the use of a graphic display device, 605. Signal input/output (I/O) device 608 can be implemented as a wide range of possible devices, including a serial connection, universal serial bus (USB), an infrared transceiver, a network adapter or a radio frequency (RF) transceiver.

### ADVANTAGES OF THE PRESENT INVENTION

Traditionally, audits provided assurance by examining and inspecting samples of transaction detail in order to assess risk and evaluate the control environment. Fieldwork examination, the most expensive and intrusive part of an audit, may take weeks or months due to the complexity of the organization. Furthermore, changes in the environment tended to lessen the reliability of testing results. Existing automated audit tools provide functionality for performing transactional data analysis and examining system configuration settings, but they do not enable the capability of continuous measurement and reporting on process-based leading indicators and symptomatic lagging indicators across multiple systems and processes simultaneously. Embodiments of the present invention provide ongoing monitoring of process-based leading indicators and symptomatic lagging indicators, making difficult things easier to see.

By systematically measuring key risk indicators, in accordance with embodiments of the present invention, controllership, corporate governance and auditors are enabled to identify, analyze and disclose changes in the control environment as required by the Sarbanes-Oxley Act of 2002. They are able to measure and respond to risk transparently and deploy resources precisely in order to cap and contain emerging risk. In addition, controllership, corporate governance and auditors are able to ensure that the control environment adapts and continues to operate effectively under accelerated change and strategically predict the effectiveness of the control environment.

When financial processes, business applications, and related IT indicators are aligned accordingly, these monitoring activities can provide assurance as to the reliability of financial reporting information that has not previously existed without performing traditional audit examinations. The continuous monitoring techniques set for the in embodiments of the present invention may be portable to globally dispersed customers with changing, complex organizations, who can benefit from prospectively measuring their own readiness in connection with Sarbanes-Oxley Act attestation efforts.

Thus, the present invention provides, in various embodiments, a method and system for automating an audit process and forecasting risk for adaptive environments. The foregoing descriptions of specific embodiments have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method for automating an audit process, comprising:
automatically accessing data pertinent to a plurality of process-based leading indicators and a plurality of symptomatic lagging indicators, wherein said plurality of process-based leading indicators is correlated with said plurality of symptomatic lagging indicators;
storing said data; and
generating results.

2. The method as recited in claim 1 further comprising:
storing in a database, where relevant, a threshold value for said data pertinent to each of said plurality of process-based leading indicators and said plurality of symptomatic lagging indicators, said threshold value indicating a level for potentially imminent risk;
trending said data;
predicting a future status of said data based on an extrapolation of said trending; and
generating an alert message when said data attains a predetermined value relative to said threshold value.

3. The method as recited in claim 1 wherein said plurality of process-based leading indicators is correlated with said plurality of symptomatic lagging indicators by analyzing empirical data.

4. The method as recited in claim 1 wherein said audit process is an Information Technology audit process.

5. The method as recited in claim 4 wherein said process-based leading indicators are aligned with a relevant category.

6. The method as recited in claim 5 wherein said relevant category is security.

7. The method as recited in claim 6 wherein said relevant category is maintenance.

8. A method of forecasting effectiveness and efficiency of controls using process-based indicators, comprising:
storing in a database, where relevant, a threshold value for each of a plurality of process-based leading indicators and a plurality of symptomatic lagging indicators, said threshold value indicating a level of risk corresponding to an imminent loss of control;
accessing data pertinent to a plurality of process-based leading indicators and a plurality of symptomatic lagging indicators, said process-based leading indicators correlated with said plurality of symptomatic lagging indicators;
storing said data;
trending said data;
predicting a future status of said data based on an extrapolation of said trending; and
generating results.

9. The method as recited in claim 8 wherein said correlating comprises analyzing empirical data.

10. The method as recited in claim 8 wherein said controls relate to an Information Technology audit process.

11. The method as recited in claim 10 wherein said process-based leading indicators are aligned with a relevant category.

12. The method as recited in claim 11 wherein said relevant category is security.

13. The method as recited in claim 11 wherein said relevant category is availability.

14. The method as recited in claim 8 wherein said report is a graph.

15. A forecasting system for predicting the effectiveness and efficiency of controls using process-based indicators, comprising:
a monitoring system configured to be coupled to an application for monitoring and storing data pertinent to said process-based indicators;
a database coupled to said monitoring system, said database comprising threshold values for said data pertinent to said process-based indicators, said threshold values indicative of imminent loss of control;
a comparator coupled to said monitoring system for comparing said data to said threshold values; and

16. The forecasting system of claim 15 wherein said process-based indicators comprise a plurality of leading indicators correlated to a plurality of symptomatic lagging indicators.

17. The forecasting system of claim 16 where in said indicators are correlated by analyzing empirical data.

18. The forecasting system of claim 15 wherein said controls relate to an Information Technology audit process.

19. The forecasting system of claim 18 wherein said indicators are aligned with a relevant category.

20. The forecasting system of claim 19 wherein said relevant category is availability.

21. The forecasting system of claim 19 wherein said relevant category is maintenance.

22. The forecasting system of claim 15 wherein said monitoring system issues an alert message when said comparator determines that said data has attained a predetermined value relative to said threshold value.

23. The forecasting system of claim 15 further comprising a results generator for generating a report.

24. A computer-usable medium having computer-readable code embodied therein for causing a computer system to perform a method for automating an audit process, comprising:
automatically accessing data pertinent to a plurality of process-based leading indicators and a plurality of symptomatic lagging indicators, wherein said plurality of process-based leading indicators is correlated with said plurality of symptomatic lagging indicators;
storing said data; and
generating results.

25. The computer-usable medium of claim 24 having computer-readable code embodied therein for causing a computer system to perform a method for automating an audit process, further comprising:
storing in a database, where relevant, a threshold value for said data pertinent to each of said plurality of process-based leading indicators and said plurality of symptomatic lagging indicators, said threshold value indicating a level for potentially imminent risk;
trending said data;
predicting a future status of said data based on an extrapolation of said trending; and
generating an alert message when said data attains a predetermined value relative to said threshold value.

26. The computer-usable medium of claim 24 wherein said plurality of process-based leading indicators is correlated with said plurality of symptomatic lagging indicators based on empirical data.

27. The computer-usable medium of claim 24 wherein said audit process relates to an Information Technology audit process.

28. The computer-usable medium of claim 27 wherein said process-based indicators are aligned with a relevant category.

29. The computer-usable medium of claim 28 wherein said relevant category is security.
